(19) United States
(12) Patent Application Publication
(10) Pub. No.: US 2007/0118907 A1
(43) Pub. Date: May 24, 2007

(54) Management equipment for mission critical system

(76) Inventor: Byung-Rong Min, Suwon-Si (KR)

Correspondence Address: CANTOR COLBURN, LLP, 55 GRIFFIN ROAD SOUTH, BLOOMFIELD, CT, 06002, US

(21) Appl. No.: 11/269,059

(22) Filed: Nov. 8, 2005

(51) Int. Cl. G06F 12/14

(52) U.S. Cl. 726/23

(57) ABSTRACT

A management equipment for mission critical system (MCS) is provided wherein the management equipment for MCS is disposed in front of MCS associated with productive facilities and has a same IP address as that of the MCS to thereby prevent malignant codes from flowing into the MCS by limiting TCP/UDP ports that are available to connect to a network. Thus, in case of a normal communication state, packet data transmitted and received between the MCS and an external device is delivered to a connection limitation unit and then analyzed therein to thereby prevent various kinds of malignant codes from penetrating into the MCS. And, in case of an abnormal communication state, the transmission and reception of the packet data between the MCS and the external device is made without passing through the connection limitation unit, thereby maintaining high availability under a minimum influence of the communication state between the MCS and the external device.

### BACKGROUND OF THE INVENTION

1. Field of the Invention

The present invention is directed to a management equipment for mission critical system (MCS), and more particularly, to a management equipment for MCS that is capable of preventing various kinds of malignant codes from flowing into an MCS upon communication between the MCS and an external device coupled therewith via a network and also realizing high availability.

2. Description of Related Art MCS may induce fatal life damage or property loss when a trouble takes place therein. A variety of MCS's have been utilized over the general industry field of semiconductor production line, LCD production line, etc.

FIG. 1 is a schematic view showing a construction of a conventional MCS and virus infection paths. As depicted therein, the MCS 100 is connected to a production line network and communicates with external devices 200. Each of the external devices 200 is disposed on a production line, in offices, or in the outside; and is coupled with the MCS 100 via the production line network or office network to communicate therewith.

In this configuration, there is a high possibility of infiltrating various kinds of malignant codes such as hacking, virus, warm, etc. into the MCS 100 via various paths. To preclude such problem, in prior art method, OS (Operating System) security patch is performed in the MCS 100, or anti virus programs are installed and updated therein, as shown in FIG. 2, thereby preventing the infiltration of the malignant codes into the MCS 100.

In such a case, however, high possibility has existed for low productivity and availability due to various reasons such as collision problem with other applications being operated in the MCS 100, hard disc destruction problem of the MCS 100, operation halt problem of the MCS 100 during the rebooting thereof, after performing the OS security patch or installing or updating the anti virus programs, etc.

To solve such problems, hardware firewall may be used, but it was difficult to prepare hardware firewall that is suitable for the use of the MCS 100 that takes into account availability as a matter of the highest priority, as in semiconductor production line, LCD production line, or the like. Moreover, the availability of hardware firewall itself affects availability of the whole system, which results in a possibility to raise a reverse effect that the hardware firewall obstructs availability improvement rather.

As shown in FIG. 3, in a state that a system A communicates with a system B, it is first assumed that availability of each of the systems A and B is 99%, and availability of the whole system is 98% owing to mutual effects of the both systems. Under the assumption, if a system C (e.g., hardware firewall) with availability of 99% is connected between the systems A and B and thus the availability of the whole system is about 97% because the system C affects availability of the whole system, the availability of the whole system after coupling with the system C is lower than that of the original whole system if availability lowering due to virus is 0.5%. As a result, a reverse effect is occurred rather, in light of availability.

In view of the foregoing, the inventors of the present invention tried to study a management equipment for MCS that is capable of stably protecting MCS from malignant codes of hacker attack, virus, warm, etc., while maintaining high availability.

### SUMMARY OF THE INVENTION

The present invention is invented under the intent as set forth above. Therefore, a primary objective of the present invention is to provide a management equipment for MCS that is capable of stably protecting MCS from various kinds of malignant codes, while maintaining high availability.

In accordance with the present invention, there is provided a management equipment for Mission Critical System (MCS), wherein the management equipment for MCS is prepared in front of MCS associated with productive facilities and has a same IP address as that of the MCS, to thereby prevent malignant codes from flowing into the MCS by limiting TCP/UDP ports that are available to connect to a network.

Accordingly, the present invention can stably protect MCS by preventing various kinds of malignant codes from coming into MCS using the management equipment for MCS where necessary, without any manipulation to limit network functions of MCS itself which is strictly limited to change the system itself or manipulate it.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view showing a construction of conventional MCS and virus infection paths;

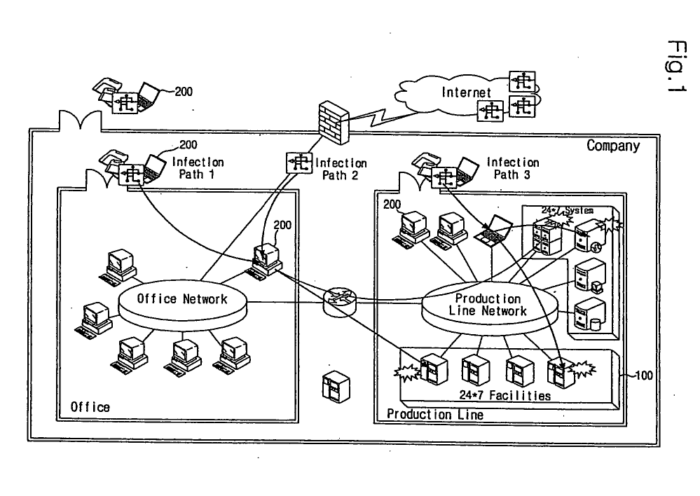

FIG. 2 is a schematic view presenting a solution for anti virus of a conventional MCS;

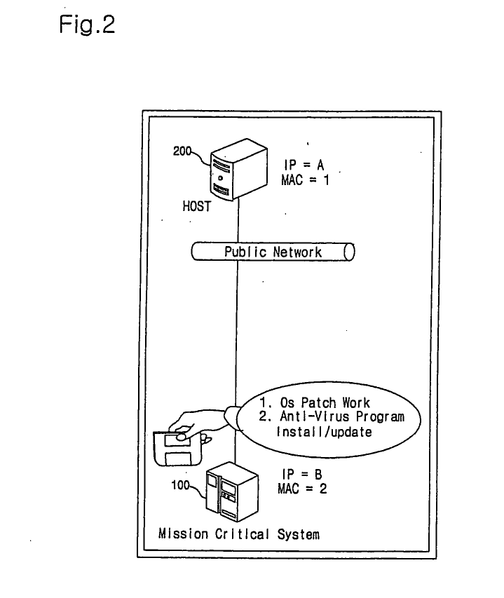

FIG. 3 is a view of explaining high availability;

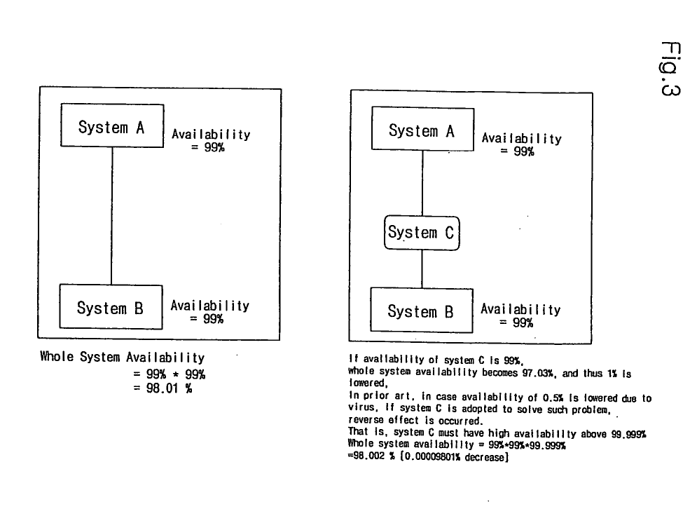

FIG. 4 is an exemplary schematic view showing a construction of MCS to which a management equipment for MCS in accordance with the present invention is applied; and

FIG. 5 is an exemplary block diagram illustrating an embodiment of the management equipment for MCS in accordance with the present invention.

### DETAILED DESCRIPTION OF THE INVENTION

An exemplary embodiment according to the present invention will now be described in detail with reference to the accompanying drawings so that a person skilled in the art can readily understand and carry out the invention.

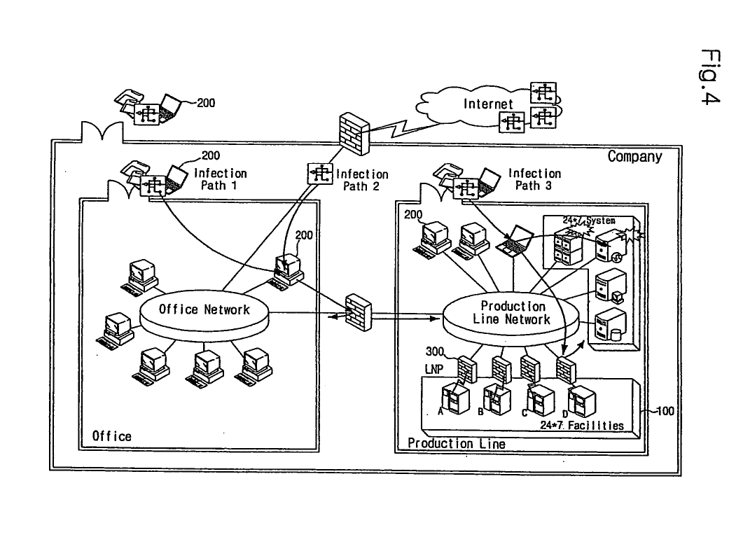

FIG. 4 is an exemplary schematic view showing a construction of MCS to which a management equipment 300 for MCS according to the present invention is applied. As illustrated therein, the management equipment 300 for MCS of the present invention is exposed in front of MCS that is controlled by external devices 200. The inventive management equipment 300 for MCS is installed ahead each of MCS's 100 associated with production facilities and has a same IP address as that of each MCS 100, wherein malignant codes are prevented from flowing into each MCS 100 by limiting TCP/UDP ports that are likely to connect to a network.

That is to say, the inventive management equipment 300 for MCS performs an authentication process with respect to the MCS 100 and the external device 200 based on an authorized IP address used in an authorized network, and then identifies them so that a point-to-point application can be carried out smoothly between the MCS 100 and the external device 200. For this, the inventive management equipment 300 for MCS searches whether or not IP address and MAC address of a source side and those of a destination side with respect to packet data are registered addresses, by referring inherent IP addresses and MAC addresses of registered MCS and external devices, and then performs the authentication process.

On the other hand, in case an abnormal communication is made between the MCS 100 and the external device 200, the present invention realizes high availability by processing data to be directly transmitted from the external device 200 to the MCS 100, without performing its data packet analysis, in order to maintain a normal communication state therebetween.

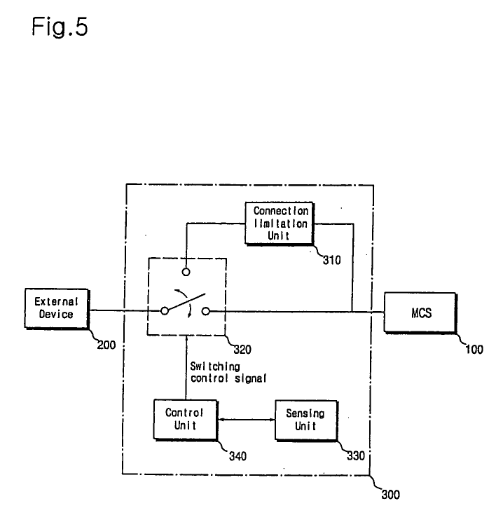

Now, a concrete construction and operational effects of the management equipment 300 for MCS of the invention will be described referring to FIG. 5. FIG. 5 is an exemplary block diagram illustrating an embodiment of the management equipment for MCS according to the present invention. As shown therein, the inventive management equipment 300 for MCS comprises a connection limitation unit 310, a switch 320, a sensing unit 330 and a control unit 340.

Specifically, the connection limitation unit 310 performs a communication of data that is transmitted and received between the MCS 100 and the external device 200 coupled therewith via a network using a specific port of the TCP/UDP ports. Namely, the connection limitation unit 310 transmits and receives data communicated between the MCS 100 and the external device 200 using a specific nonuse port that is not used up to now among, e.g., 65535 TCP/UDP ports, thereby protecting the system from a port attack by various kinds of malignant codes such as hacking, warm, virus, etc. The external device 200 may be one of a personal computer, central server, other MCS, and so on, and inevitably needs to use a limited specific port in order to access to the MCS 100.

Further, according to the present invention, the connection limitation unit 310 analyses a header of a data packet being transmitted from the external device 200 to the MCS 100, confirms whether or not the data packet is being transmitted to a destination that corresponds to an IP address of the MCS 100 via a set specific port and authenticates the data packet if the confirmation result is affirmative, and transmits the authenticated data packet to the MCS 100. Upon failure of the authentication, the connection limitation unit 310 carries out an anti virus function that prevents various kinds of malignant codes such as hacking, warm attack, virus, etc, from flowing into the MCS 100 by cutting off inflow of authentication-failed data packet into the MCS 100. For this, the connection limitation unit 310 searches whether or not IP address and MAC address of a source side and those of a destination side with respect to the packet data are registered addresses based on inherent IP addresses and MAC addresses of registered MCS and external devices, and then performs the authentication process.

In accordance with the invention, it may be implemented that the inventive search and authentication process can be performed with respect to the IP address and MAC address of the destination side merely or both of those of the source side and the destination side for more stable connection limitation by the external devices, according to a rule set for searching with respect to the registered addresses.

In the meantime, the switch 320 serves to switch a connection path to allow the data transmitted and received between the MCS 100 and the external device 200 coupled therewith via the network to go through or bypass the connection limitation unit 310. That is, the switch 320 selectively changes a packet data transmission path to have the data transmitted and received between the MCS 100 and the external device 200 to go through or bypass the connection limitation unit 310, according to a switching control signal determined by a communication state therebetween, thereby achieving high availability.

Specifically, in case of the normal communication state, the switch 320 sets the packet data transmission path so that the data transmitted and received between the MCS 100 and the external device 200 is allowed to pass through the connection limitation unit 310. Through this arrangement, the packet data transmitted and received between the MCS 100 and the external device 200 is analyzed in the connection limitation unit 310, and thus no malignant code is transferred to the MCS 100.

However, in case of the abnormal communication state, indicating that a CPU use rate of the management equipment 300 for MCS is above a reference value and thus an overload is taken thereto, a power is not supplied to the management equipment 300 for MCS due to a power malfunctioning, or the management equipment 300 for MCS is abnormally operated, the switch 320 sets the packet data transmission path so that the data transmitted and received between the MCS 100 and the external device 200 is permitted to bypass the connection limitation unit 310. By this configuration, the packet data transmitted and received between the MCS 100 and the external device 200 is no longer analyzed, thereby accomplishing high availability more efficiently.

The sensor 330 is configured to sense the communication state between the MCS 100 and the external device 200. In other words, the sensor 330 senses the communication state between the MCS 100 and the external device 200 at a real time in order to detect the abnormal communication state that the CPU use rate of the management equipment 300 for MCS is above the reference value and thus an overload is taken thereto, a power is not supplied to the management equipment 300 for MCS due to a power malfunctioning, or the management equipment 300 for MCS is abnormally operated. Since this communication state sensing process is already known in various manners in the art before filing the invention, details thereof are omitted here for the sake of brevity.

The controller 340 provide the switch 320 with the switching control signal to get the data transmitted and received between the MCS 100 and the external device 200 to bypass the connection limitation unit 310 if the communication state between the MCS 100 and the external device 200 is sensed as the abnormal state by the sensor 330. That is, the controller 340 generates a switching control signal to allow the data transmitted and received between the MCS 100 and the external device 200 to pass through the connection limitation unit 310 if it is judged that the communication state between the MCS 100 and the external device 200 is normal; and a switching control signal to have the data transmitted and received between the MCS 100 and the external device 200 to bypass the connection limitation unit 310 if it is judged that the communication state between the MCS 100 and the external device 200 is abnormal. The switching control signal so generated is then provided to the switch 320. Accordingly, the invention can prevent various kinds of malignant codes from infiltrating into the MCS 100, and also maintain high availability under a minimum influence of the communication state between the MCS 100 and the external device 200.

In short, the management equipment 300 for MCS according to the invention senses the communication state between the MCS 100 and the external device 200 through the sensor 330 and then provides the switch 320 with the switching control signal depending upon the sensed communication state, to allow the data transmitted and received between the MCS 100 and the external device 200 to pass through or bypass the connection limitation unit 310, wherein in response to the switch control signal, the switch 320 is switched accordingly. In case of the normal communication state, the packet data transmitted and received between the MCS 100 and the external device 200 is delivered to the connection limitation unit 310 and then analyzed therein to thereby prevent various kinds of malignant codes from penetrating into the MCS 100. And, in case of the abnormal communication state, the transmission and reception of the packet data between the MCS 100 and the external device 200 is made without passing through the connection limitation unit 310, thereby maintaining high availability under a minimum influence of the communication state between the MCS 100 and the external device 200.

As a result, the management equipment for MCS according to the invention has an advantage in that, in case where a communication state between the MCS and an external device is normal, packet data transmitted and received between the MCS and the external device is delivered to a connection limitation unit and then analyzed therein to thereby prevent various kinds of malignant codes from penetrating into the MCS; and upon an abnormal communication state, the transmission and reception of the packet data between the MCS and the external device is made without passing through the connection limitation unit to thereby prevent various kinds of malignant codes from penetrating into the MCS under a minimum influence of the communication state between the MCS and the external device while maintaining high availability.

As described above, the present invention can achieve the object of the invention through the use of the efficient management equipment for MCS, as set forth above.

While the present invention has been described with reference to exemplary embodiments thereof, it will be understood by those skilled in the art that various changes in form and details may be made therein without departing from the scope of the present invention as defined by the following claims.

What is claimed is:

1. A management equipment for Mission Critical System (MCS), wherein the management equipment for MCS is prepared in front of MCS associated with productive facilities and has a same IP address as that of the MCS, to thereby prevent malignant codes from flowing into the MCS by limiting TCP/UDP ports that are available to connect to a network.

2. The management equipment for MCS as recited in claim 1, comprising a connection limitation unit for performing a communication of data that is transmitted and received between the MCS and an external device coupled with the MCS via the network using a specific port among the TCP/UDP ports.

3. The management equipment for MCS as recited in claim 2, wherein the connection limitation unit analyses a header of a data packet being transmitted from the external device to the MCS, confirms whether or not the data packet is being transmitted to a destination that corresponds to the IP address of the MCS via the specific port and authenticates the data packet if the confirmation result is affirmative, and transmits the authenticated data packet to the MCS.

4. The management equipment for MCS as recited in claim 2, further comprising:
a switch for switching a connection path to allow the data transmitted and received between the MCS and the external device coupled with the MCS via the network to pass through or bypass the connection limitation unit;
a sensor for sensing a communication state between the MCS and the external device; and
a controller for providing the switch with a switch control signal to allow the data transmitted and received between the MCS and the external device to bypass the connection limitation unit when the sense result by the sensor indicates an abnormal communication state between the MCS and the external device.

5. The management equipment for MCS as recited in claim 3, wherein the connection limitation unit analyses a header of a data packet being transmitted from the external device to the MCS, confirms whether or not the data packet is being transmitted to a destination that corresponds to the IP address of the MCS via the specific port and authenticates the data packet if the confirmation result is affirmative, and transmits the authenticated data packet to the MCS.

6. The management equipment for MCS as recited in claim 5, wherein, upon failure of the authentication, the connection limitation unit prevents authentication-failed data packet from transferring to the MCS.

7. The management equipment for MCS as recited in claim 4, wherein the sensor judges the communication state between the MCS and the external device as an abnormal state when a CPU use rate of the management equipment for MCS sensed at a real time is above a reference value, a power is not supplied to the management equipment due to a power malfunctioning, or the management equipment for MCS is abnormally operated.

8. The management equipment for MCS as recited in claim 5, wherein the connection limitation unit further confirms whether or not the data packet is a data packet transmitted from an IP address of the external device that is allowed to access to the MCS.
